(19) United States
(12) Patent Application Publication
(10) Pub. No.: US 2012/0305191 A1
(43) Pub. Date: Dec. 6, 2012

(54) APPARATUS FOR TREATING SUBSTRATE

(75) Inventors: Sangmin Mun, Chungcheongnam-do (KR); Dosoon Kim, Chungcheongnam-do (KR); Daehyun Yang, Gyeonggi-do (KR)

(73) Assignee: SEMES CO., LTD., Cheonan-si (KR)

(21) Appl. No.: 13/483,661

(22) Filed: May 30, 2012

(30) Foreign Application Priority Data
May 31, 2011 (KR) 10-2011-0052433
Sep. 1, 2011 (KR) 10-2011-0088472

(51) Int. Cl. H05H 1/24; B44C 1/22

(52) U.S. Cl. 156/345.44; 156/345.37

(57) ABSTRACT

Provided is an apparatus for treating a substrate. The apparatus for treating a substrate may include a process chamber having a space formed therein, a chuck positioned in the process chamber and supporting a substrate, a gas supply unit supplying reaction gas into the process chamber, an upper electrode positioned above the chuck and applying high frequency power to the reaction gas, and a heater installed in the upper electrode and heating the upper electrode.

### CROSS-REFERENCE TO RELATED APPLICATIONS

This U.S. non-provisional patent application claims priority under 35 U.S.C. §119 of Korean Patent Applications Nos. 10-2011-0052433, filed on May 31, 2011, and 10-2011-0088472, filed on Sep. 1, 2011, the entire contents of which are hereby incorporated by reference.

### BACKGROUND

The present invention disclosed herein relates to an apparatus for treating a substrate, and more particularly, to an apparatus for treating a substrate by using plasma.

Plasma is generated at very high temperature or by strong electric fields or radio frequency (RF) electromagnetic fields, and denoted as an ionized gas state formed of ions, electrons, or radicals. In semiconductor device fabrication processes, an etching process is performed by using plasma. The etching process is performed by allowing ion particles contained in the plasma to collide with a substrate.

FIG. 1 is a graph showing etch rates of substrates, in which etching processes are performed by using a general substrate treating apparatus. Referring to FIG. 1, the etch rate does not reach a base etch rate L until treatments of about five substrates are completed after the etching process started. This means that process gas is not sufficiently excited until the treatments of about five substrates are completed after the etching process started. As a result, since a predetermined time is required for obtaining an etch rate near the base etch rate L, a total processing time for treating the substrates may increase. Also, since the etch rates of the substrates provided at an initial stage of the process do not reach the base etch rate, a substrate treating efficiency may decrease.

### SUMMARY

The present invention provides an apparatus for treating a substrate able to reduce a total processing time.

The present invention also provides an apparatus for treating a substrate able to prevent generation of a substrate treated at an etch rate lower than a base etch rate.

Embodiments of the present invention provide apparatuses for treating a substrate including: a process chamber having a space formed therein; a chuck positioned in the process chamber and supporting a substrate; a gas supply unit supplying reaction gas into the process chamber; an upper electrode positioned above the chuck and applying high frequency power to the reaction gas; and a heater installed in the upper electrode and heating the upper electrode.

In some embodiments, the apparatus for treating a substrate may further include a distribution plate positioned under the upper electrode and having distribution holes allowing the reaction gas to pass through formed therein.

In other embodiments, the heater may be embedded in the upper electrode.

In still other embodiments, the apparatus for treating a substrate may further include: a first upper power source applying a first frequency power to the upper electrode; and a second upper power source applying a second frequency power to the heater. The second frequency may be different from the first frequency.

In even other embodiments, the apparatus for treating a substrate may further include a first frequency blocking filter electrically connected to the first upper power source and the upper electrode in a section between the first upper power source and the upper electrode, and blocking the first frequency power applied to the upper electrode to be applied to the first upper power source.

In yet other embodiments, the apparatus for treating a substrate may further include a second frequency blocking filter electrically connected to the second upper power source and the heater in a section between the second upper power source and the heater, and blocking the second frequency power applied to the heater to be applied to the second upper power source.

In further embodiments, the upper electrode may include: an upper plate electrically connected to the first upper power source; and a lower plate positioned under the upper plate, having the heater installed therein, and having gas supply holes supplying process gas formed therein.

In still further embodiments, the lower plate may include: a center region having the gas supply holes formed therein; and an edge region surrounding the center region, wherein the heater may be provided in the edge region and may surround the center region.

In even further embodiments, the first frequency power may have a frequency range of about 13.56 MHz to about 100 MHz and the second frequency power may have a frequency of about 60 Hz.

In yet further embodiments, the apparatus for treating a substrate may further include: a lower electrode installed in the chuck; a first lower power source generating the same frequency power as the first frequency power; a second lower power source generating a frequency power lower than the first frequency power; and a matching unit matching the frequency power generated from the first lower power source and the frequency power generated from the second lower power source, and applying the matched frequency power to the lower electrode.

In much further embodiments, the first lower power source may generate a frequency power of about 100 MHz and the second lower power source may generate a frequency power of about 2 MHz.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a graph showing etch rates of substrates, in which etching processes are performed by using a general substrate treating apparatus;

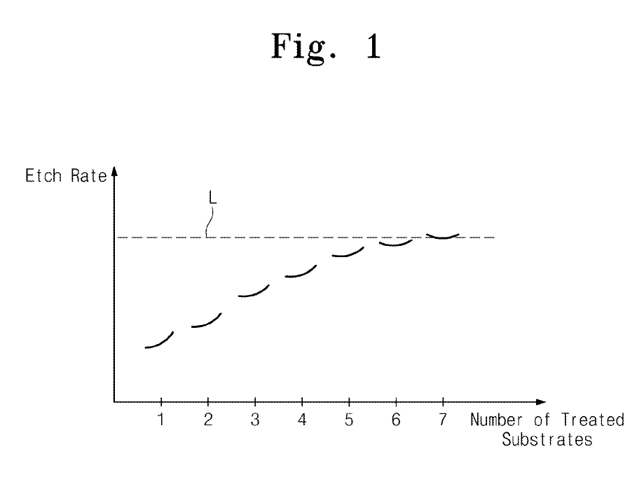

FIG. 2 is a cross-sectional view illustrating an apparatus for treating a substrate according to an embodiment of the present invention;

FIG. 3 is a cross-sectional view illustrating an apparatus for treating a substrate according to another embodiment of the present invention; and

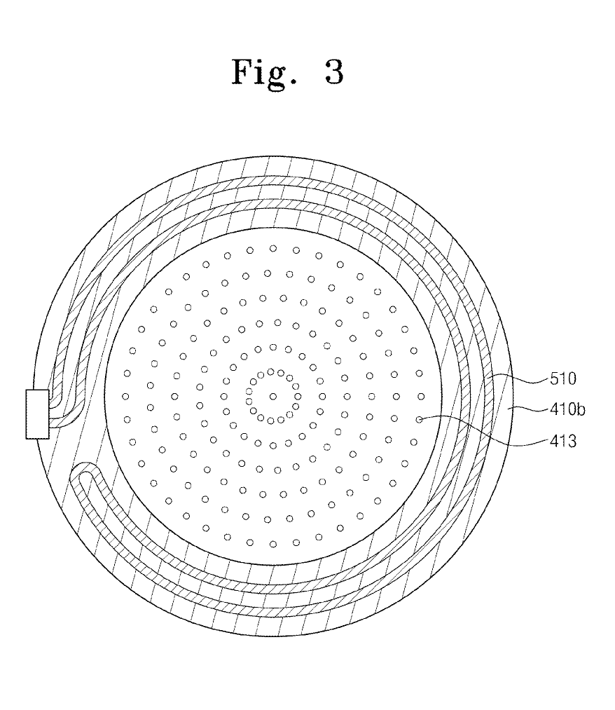

FIG. 4 is a graph showing etch rates of substrates treated by using the apparatus for treating a substrate according to the embodiments of the present invention.

### DETAILED DESCRIPTION OF THE EMBODIMENTS

Hereinafter, an apparatus for treating a substrate according to preferred embodiments of the present invention will be described in detail with reference to the accompanying drawings. Moreover, detailed descriptions related to well-known functions or configurations will be ruled out in order not to unnecessarily obscure subject matters of the present invention.

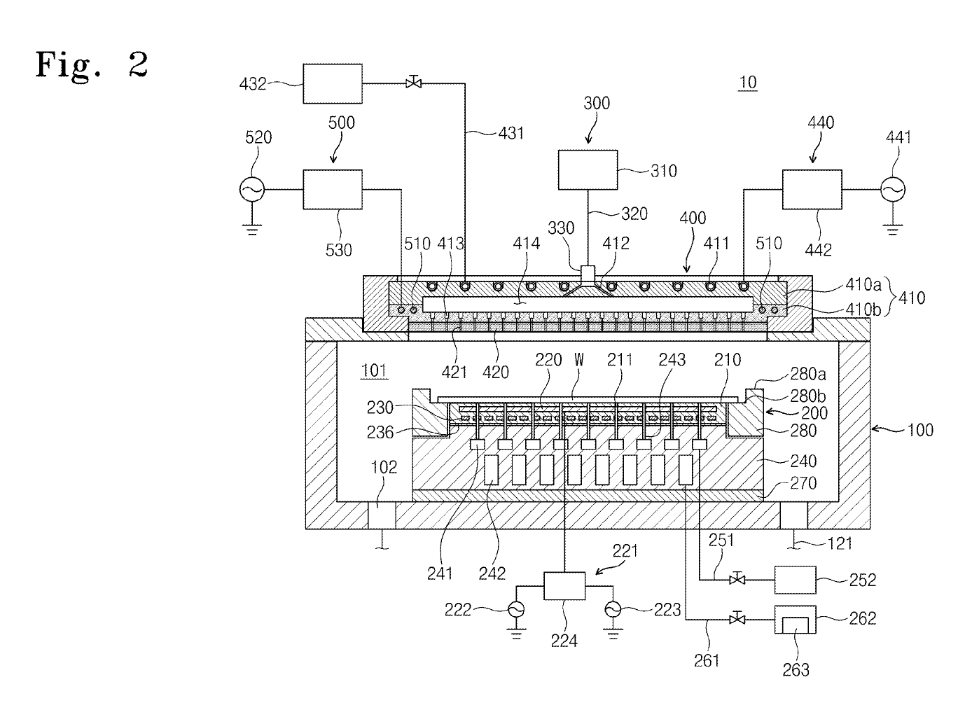

FIG. 2 is a cross-sectional view illustrating an apparatus for treating a substrate according to an embodiment of the present invention.

Referring to FIG. 2, an apparatus 10 for treating a substrate generates plasma to treat a substrate W. The apparatus 10 for treating a substrate includes a process chamber 100, a chuck 200, a gas supply unit 300, a plasma generation unit 400, and a heating unit 500.

A space 101 is formed in the process chamber 100. The inner space 101 is proved as a space for performing a plasma process treatment on the substrate W. The plasma treatment on the substrate W includes an etching process. Exhaust holes 102 are formed at a bottom of the process chamber 100. The exhaust holes 102 are connected to exhaust lines 121. Reaction byproducts generated during the process and gas remaining in the process chamber 100 may be discharged to the outside through the exhaust lines 121. The inner space 101 of the process chamber 100 is decompressed at a predetermined pressure by an exhaust process.

The chuck 200 is positioned in the process chamber 100. The chuck 200 supports the substrate W. The chuck 200 includes an electrostatic chuck 200 adsorbing and fixing the substrate W by using an electrostatic force. The electrostatic chuck 200 includes a dielectric plate 210, a lower electrode 220, a heater 230, a support plate 240, and an insulation plate 270.

The dielectric plate 210 is positioned at an upper end portion of the electrostatic chuck 200. The dielectric plate 210 is provided in a disc-shaped dielectric substance. The substrate W is disposed on the dielectric plate 210. A top of the dielectric plate 210 has a radius smaller than that of the substrate W. As a result, an edge region of the substrate W is positioned outside the dielectric plate 210. First supply channels 211 are formed in the dielectric plate 210. The first supply channels 211 are provided form the top to a bottom of the dielectric plate 210. The first supply channels 211 are spaced apart from one another and formed in plural, and are provided as paths for supplying a heat transfer medium to a bottom of the substrate W.

The lower electrode 220 and the heater 230 are embedded in the dielectric plate 210. The lower electrode 220 is positioned above the heater 230. The lower electrode 220 is connected to a lower power supply unit 221. The lower power supply unit 221 applies power to the lower electrode 220. The lower power supply unit 221 includes two lower power sources 222 and 223 and a matching unit 224. The first and second lower power sources 222 and 223 generate frequency powers having different magnitudes. The first lower power source 222 may generate a frequency power higher than that of the second lower power source 224. The first lower power source 222 may generate a frequency power ranging from about 13.56 MHz to about 100 MHz and the second lower power source 223 may generate a frequency power of about 2 MHz. The matching unit 224 is electrically connected to the first and second lower power sources 222 and 223 and matches two frequency powers having different magnitudes to apply to the lower electrode 220. An electrostatic force acts between the lower electrode 220 and the substrate W according to the power applied to the lower electrode 222, and the substrate W is adsorbed on the dielectric plate 210 by the electrostatic force.

The heater 230 is electrically connected to an external power source (not shown). The heater 230 generates heat by resisting a current applied from the external power source. The generated heat is transferred to the substrate W through the dielectric plate 210. The substrate W is maintained at a predetermined temperature by the heat generated from the heater 230. The heater 230 includes a spiral coil. The heater 230 may be embedded 210 in the dielectric plate 210 at a uniform spacing.

The support plate 240 is positioned under the dielectric plate 210. The bottom of the dielectric plate 210 and a top of the support plate 240 may be bonded with an adhesive 236. The support plate 240 may be provided in an aluminum material. The top of the support plate 240 may have a step height such that a center region is positioned higher than an edge region. The center region of the top of the support plate 240 has an area corresponding to that of the bottom of the dielectric plate 210 and is in contact with the bottom of the dielectric plate 210. A first circulation channel 241, a second circulation channel 242, and a second supply channel 243 are formed in the support plate 240.

The first circulation channel 241 is provided as a path for circulating the heat transfer medium. The first circulation channel 241 may be formed in a spiral shape in the support plate 240. Also, the first circulation channel 241 may be arranged to allow ring-shaped channels having different radii to have the same center. The respective first circulation channels 241 may be connected through one another. The first circulation channels 241 are formed at the same height.

The second circulation channel 242 is provided as a path for circulating a cooling fluid. The second circulation channel 242 may be formed in a spiral shape in the support plate 240. Also, the second circulation channel 242 may be arranged to allow ring-shaped channels having different radii to have the same center. The respective second circulation channels 242 may be connected through one another. The second circulation channel 242 may have a cross-sectional area greater than that of the first circulation channel 241. The second circulation channels 242 are formed at the same height. The second circulation channel 242 may be positioned under the first circulation channel 241.

The second supply channel 243 extends from the first circulation channel 241 to the above and is provided above the support plate 240. The second supply channels 243 are provided by the number corresponding to that of the first supply channels 211 and connect between the first circulation channels 241 and the first supply channels 211.

The first circulation channel 241 is connected to a heat transfer medium storage unit 252 through a heat transfer medium supply line 251. The heat transfer medium storage unit 252 stores the heat transfer medium. The heat transfer medium includes inert gas. According to an embodiment of the present invention, the heat transfer medium includes helium (He) gas. The He gas is supplied to the first circulation channel 241 through the supply line 251 and is supplied to the bottom of the substrate W by sequentially passing through the second supply channel 243 and the first supply channel 211. The He gas functions as a medium for transferring the heat transferred from the plasma to the substrate W to the electrostatic chuck 200. Ion particles contained in the plasma are attracted by the electrostatic force formed at the electrostatic chuck 200 to move to the electrostatic chuck 200 and collide with the substrate W during the movement to perform an etching process. Heat generates in the substrate W during the ion particles collide with the substrate W. The heat generated in the substrate W is transferred to the electrostatic chuck 200 through the He gas supplied to a space between the bottom of the substrate W and the top of the dielectric plate 210. Accordingly, the substrate W may be maintained at a set temperature.

The second circulation channel 242 is connected to a cooling fluid storage unit 262 through a cooling fluid supply line 261. The cooling fluid storage unit 262 stores the cooling fluid. A cooler 263 may be provided in the cooling fluid storage unit 262. The cooler 263 cools the cooling fluid at a predetermined temperature. Alternatively, the cooler 263 may be installed at the cooling fluid supply line 261. The cooling fluid supplied to the second circulation channel 242 through the cooling fluid supply line 261 circulates along the second circulation channel 242 and cools the support plate 240. The cooling of the support plate 240 maintains the substrate W at a predetermined temperature by cooling the dielectric plate 210 and the substrate W together.

The insulation plate 270 is provided under the support plate 240. The insulation plate 270 is provided in a size corresponding to that of the support plate 240. The insulation plate 270 is positioned between the support plate 240 and a bottom of the chamber 100. The insulation plate 270 is provided in an insulation material and electrically insulates between the support plate 240 and the chamber 100.

A focus ring 280 is disposed at an edge region of the electrostatic chuck 200. The focus ring 200 has a ring shape and is disposed along a circumference of the dielectric plate 210. A top of the focus ring 280 may have a step height such that an outside portion 280a is higher than an inside portion 280b. The inside portion 280b of the top of the focus ring 280 is positioned at the same height as that of the top of the dielectric plate 210. The inside portion 280b of the top of the focus ring 280 supports the edge region of the substrate W positioned outside the dielectric plate 210. The outside portion 280a of the focus ring 280 is provided to surround the edge region of the substrate W. The focus ring 280 expands an electric field formation region such that the substrate W is positioned at a center of a region in which the plasma is formed. Accordingly, the plasma is uniformly formed over an entire region of the substrate W and thus, each region of the substrate W may be uniformly etched.

The gas supply unit 300 supplies process gas to the process chamber 100. The gas supply unit 300 includes a gas storage unit 310, a gas supply line 320, and a gas inlet port 330. The gas supply line 320 connects between the gas storage unit 310 and the gas inlet port 330, and supplies the process gas stored in the gas storage unit 310 to the gas inlet port 330. The gas inlet port 330 is connected to gas supply holes 412 formed in an upper electrode 410.

The plasma generation unit 400 excites the process gas remaining in the process chamber 100. The plasma generation unit 400 includes the upper electrode 410, a distribution plate 420, and an upper power supply unit 440.

The upper electrode 410 is provided in a disc shape and positioned above the electrostatic chuck 200. The upper electrode 410 includes an upper plate 410a and a lower plate 410b. The upper plate 410a is provided in a disc shape. The upper plate 410a is electrically connected to a first upper power source 441. The upper plate 410a applies high frequency power generated from the first upper power source 441 to the process gas remaining in the process chamber 100 to excite the process gas. The process gas is excited to transform into a plasma state. A bottom of the upper plate 410a has a step height such that a center region is positioned higher than an edge region. The gas supply holes 412 are formed in the center region of the upper plate 410a. The gas supply holes 412 are connected to the gas inlet port 330 and supply the process gas to a buffer space 414. A cooling channel 411 may be formed in the upper plate 410a. The cooling channel 411 may be formed in a spiral shape. Also, the cooling channel 411 may be arranged to allow ring-shaped channels having different radii to have the same center. The cooling channel 411 is connected to a cooling fluid storage unit 432 through a cooling fluid supply line 431. The cooling fluid storage unit 432 stores the cooling fluid. The cooling fluid stored in the cooling fluid storage unit 432 is supplied to the cooling channel 411 through the cooling fluid supply line 431. The cooling fluid circulates in the cooling channel 411 and cools the upper plate 410a.

The lower plate 410b is positioned under the upper plate 410a. The lower plate 410b is provided in a size corresponding to that of the upper plate 410a and positioned to face the upper plate 410a. A top of the lower plate 410b has a step height such that a center region is positioned lower than an edge region. The top of the lower plate 410b and the bottom of the upper plate 410a are combined each other to form the buffer space 414. The buffer space 414 is provided as a space in which the gas supplied through the gas supply holes 412 temporarily remains before the gas is supplied into the process chamber 100. Gas supply holes 413 are formed in the center region of the lower plate 410b. The gas supply holes 413 are spaced apart at a constant spacing and formed in plural. The gas supply holes 413 are connected to the buffer space 414.

The distribution plate 420 is positioned under the lower plate 410b. The distribution plate 420 is provided in a disc shape. Distribution holes 421 are formed in the distribution plate 420. The distribution holes 421 are provided from a top of the distribution plate 420 to a bottom thereof. The distribution holes 421 are provided by the number corresponding to that of the gas supply holes 413 and positioned at positions corresponding to those at which the gas supply holes 413 are positioned. The process gas remaining in the buffer space 414 is uniformly supplied into the process chamber 100 through the gas supply holes 413 and the distribution holes 421.

The upper power supply unit 440 applies high frequency power to the upper plate 410a. The upper power supply unit 440 includes the first upper power source 441 and a filter 442. The first upper power source 441 is electrically connected to the upper plate 410a and generates high frequency power. The first upper power source 441 generates a first frequency power. The first upper power source 441 may generate the same frequency power as that of the first lower power source 222. The first upper power source 441 may generate a frequency power ranging from about 13.56 MHz to about 100 MHz.

The filter 442 is electrically connected to the first upper power source 441 and the upper plate 410a in a section between the first upper power source 441 and the upper plate 410a. The filter 442 pass the first frequency power in order for the first frequency power generated from the first upper power source 441 to be applied to the upper plate 410a. The filter 442 blocks that the first frequency power applied to the upper plate 410a is transferred to the first upper power source 441. The filter 442 includes a high-pass filter.

The heating unit 500 heats the lower plate 410b. The heating unit 500 includes a heater 510, a second upper power source 520, and a filter 530. The heater 510 is installed in the lower plate 410b. The heater 510 may be provided in an edge region of the lower plate 410b. The heater 510 includes a heating coil and may be provided to surround the center region of the lower plate 410b. The second upper power source 520 is electrically connected to the heater 510. The second upper power source 520 generates a second frequency power. The second frequency power is different from the first frequency power. The second frequency power may be provided at a frequency lower than that of the first frequency power. The second frequency power may have a frequency of about 60 Hz. The second upper power source 520 may generate a direct current power. Also, the second upper power source 520 may generate an alternating current power. The second frequency power generated from the second upper power source 520 is applied to the heater 510 and the heater 510 generates heat by resisting the applied current. The heat generated from the heater 510 heats the lower plate 410b and the heated lower plate 410b heats the distribution plate 420 positioned thereunder at a predetermined temperature. The lower plate 410b may be heated to a temperature range of about 60° C. to about 300° C.

The filter 530 is electrically connected to the second upper power source 520 and the heater 510 in a section between the second upper power source 520 and the heater 510. The filter 530 pass the second frequency power in order for the second frequency power generated from the second upper power source 520 to be applied to the heater 510. The filter 530 blocks that the second frequency power applied to the heater 510 is transferred to the second upper power source 520. The filter 530 includes a low-pass filter.

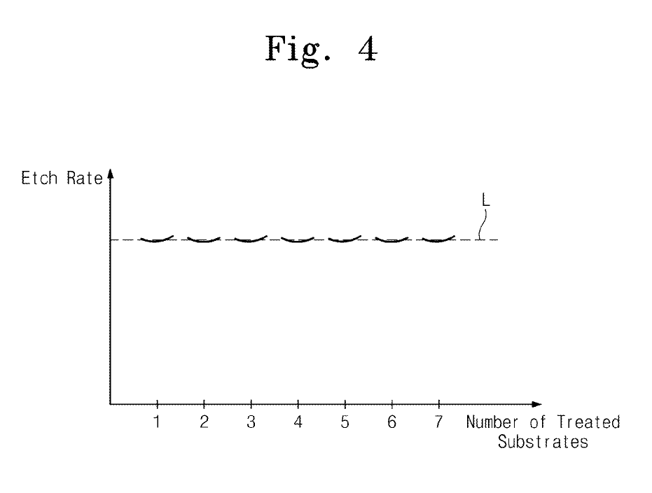

FIG. 4 is a graph showing etch rates of substrates treated by using the apparatus for treating a substrate according to the embodiments of the present invention.

Referring to FIG. 4, the substrates are sequentially provided to etching processes by plasma. As a result of etching the substrates by using the apparatus for treating a substrate of the present invention, etch rates of the substrate first provided to the etching process and the substrates provided thereafter are near the base etch rate L. The reason for this is that since the lower plate 410b and the distribution plate 420 are quickly heated to a predetermined temperature by the heat generated from the heater 510, the process gas remaining in the process chamber 100 is actively excited at an initial stage of the process. Thus, since the etch rate in the present invention reaches the base etch rate just after the etching process started, an additional time is not required for the etch rate to reach the base etch rate. Therefore, a total processing time is not only reduced, but generation of a substrate treated at an etch rate lower than the base etch rate may also be prevented.

According to the present invention, since an additional processing time is not required for a substrate treatment to reach a base etch rate, a total processing time may be reduced.

Also, according to the present invention, an etch rate of a substrate provided at an initial period of an etching process may reach the base etch rate.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the inventive concept.

What is claimed is:

1. An apparatus for treating a substrate comprising:
a process chamber having a space formed therein;
a chuck positioned in the process chamber and supporting a substrate;
a gas supply unit supplying reaction gas into the process chamber;
an upper electrode positioned above the chuck and applying high frequency power to the reaction gas; and
a heater installed in the upper electrode and heating the upper electrode.

2. The apparatus for treating a substrate of claim 1, further comprising a distribution plate positioned under the upper electrode and having distribution holes allowing the reaction gas to pass through formed therein.

3. The apparatus for treating a substrate of claim 1, wherein the heater is embedded in the upper electrode.

4. The apparatus for treating a substrate of claim 1, further comprising:
a first upper power source applying a first frequency power to the upper electrode; and
a second upper power source applying a second frequency power to the heater.

5. The apparatus for treating a substrate of claim 4, further comprising a first frequency blocking filter electrically connected to the first upper power source and the upper electrode in a section between the first upper power source and the upper electrode, and blocking the first frequency power applied to the upper electrode to be applied to the first upper power source.

6. The apparatus for treating a substrate of claim 4, wherein the second frequency is different from the first frequency.

7. The apparatus for treating a substrate of claim 4, further comprising a second frequency blocking filter electrically connected to the second upper power source and the heater in a section between the second upper power source and the heater, and blocking the second frequency power applied to the heater to be applied to the second upper power source.

8. The apparatus for treating a substrate of any one of claim 1, wherein the upper electrode comprises:
an upper plate electrically connected to the first upper power source; and
a lower plate positioned under the upper plate, having the heater installed therein, and having gas supply holes supplying process gas formed therein.

9. The apparatus for treating a substrate of claim 8, wherein the lower plate comprises:
a center region having the gas supply holes formed therein; and
an edge region surrounding the center region,
wherein the heater is provided in the edge region and surrounds the center region.

10. The apparatus for treating a substrate of any one of claim 3, wherein the first frequency power has a frequency range of about 13.56 MHz to about 100 MHz and the second frequency power has a frequency of about 60 Hz.

11. The apparatus for treating a substrate of any one of claim 3, further comprising:
a lower electrode installed in the chuck;
a first lower power source generating the same frequency power as the first frequency power;
a second lower power source generating a frequency power lower than the first frequency power; and
a matching unit matching the frequency power generated from the first lower power source and the frequency power generated from the second lower power source, and applying the matched frequency power to the lower electrode.

12. The apparatus for treating a substrate of claim 11, wherein the first lower power source generates a frequency power of about 100 MHz and the second lower power source generates a frequency power of about 2 MHz.
